(19) United States
(12) Patent Application Publication
(10) Pub. No.: US 2025/0348842 A1
(43) Pub. Date: Nov. 13, 2025

(54) ARTIFICIAL INTELLIGENCE-BASED DOCUMENT AND LIFE CYCLE COST ANALYSIS METHOD FOR SOLAR ENERGY CONTRACTS

(71) Applicants: Liangcai Tan, Dublin, CA (US); Hubert Tan, Dublin, CA (US); Sherry Hu, Dublin, CA (US)

(72) Inventors: Liangcai Tan, Dublin, CA (US); Hubert Tan, Dublin, CA (US); Sherry Hu, Dublin, CA (US)

(21) Appl. No.: 18/659,020

(22) Filed: May 9, 2024

(51) Int. Cl. G06Q 10/10; G06Q 50/06

(52) U.S. Cl. CPC G06Q 10/10; G06Q 50/06

(57) ABSTRACT

An artificial intelligence-based document and life cycle cost analysis method for solar energy contracts. This method includes two main modules, the AI-based document analysis module and the life cycle costs analysis module. The AI-based document analysis module uses natural language processing (NLP) and a generative pre-trained transformer (GPT) to summarize the key insights and deficiencies of a solar energy proposal or contract and extract the necessary input data for a life cycle cost analysis. The life cycle cost analysis module accepts the input data from the AI-based document analysis module, acquires additional data from other sources like the internet and runs the life cycle cost analysis for the solar energy proposal or contract. The entire process is automated to minimize human error and maintain high industry standards from start to finish. This ensures that the results are both professional and comprehensible for the average property owner.

### FIELD OF THE INVENTION

The present invention relates to artificial intelligence (AI) and software and, more particularly, to artificial intelligence software for solar energy contracts.

### BACKGROUND OF THE INVENTION

The widespread adoption of solar photovoltaic (PV) installations is a significant measure against climate change, with an increasing number of residential and commercial property owners in the United States considering these systems. These systems, which may include both solar energy production and battery electricity storage, present complex contracts that many property owners are not familiar with. The contracts can vary greatly, depending on whether the system includes an energy storage unit, and the terms of acquisition-whether through purchase, leasing, or power purchase agreements (PPA). Often, these contracts also involve loans, maintenance requirements, and warranties, with banks and property insurance companies playing crucial roles.

Given the technical complexity and financial implications of solar energy systems, property owners often rely on salespeople for information. However, the contracts are detailed and can be dozens of pages long, making them difficult for the average property owner to understand. This challenge is compounded when multiple proposals are considered simultaneously, each potentially featuring different hardware, software, and financial arrangements.

To aid in decision-making, life cycle cost (LCC) analysis is a valuable tool. It helps compare the total costs of different energy projects over their lifespans, yet many property owners are unaware of this method. Software tools like PV F-Chart, OpenSolar, SAM (System Advisor Model), and Helioscope, developed by institutions such as the National Renewable Energy Laboratory (NREL), can facilitate these analyses. However, they require manual input of specific data about location, solar system specifications, and financials, which can be challenging for property owners to obtain accurately.

### SUMMARY OF THE INVENTION

Described is an artificial intelligence-based document and life cycle cost analysis method for solar energy contracts. This method includes two main modules, the AI-based document analysis module and the life cycle cost analysis module. The AI-based document analysis module uses natural language processing (NLP) and a generative pre-trained transformer (GPT) to summarize the key insights and deficiencies of a solar energy proposal or contract and extract the necessary input data from the solar energy proposal or contract for a life cycle cost analysis. The life cycle cost analysis module accepts the input data from the AI-based document analysis module, acquires additional data from other sources like the internet and runs the life cycle cost analysis for the subject solar energy proposal or contract. The entire process is automated to minimize human error and maintain high industry standards from start to finish. This ensures that the results are both professional and comprehensible for the average property owner.

The present invention aims to solve these problems by developing an automated artificial intelligence-based document and life cycle cost analysis method for solar energy contracts.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an overview of the artificial intelligence-based document and life cycle cost analysis method for solar energy contracts;

FIG. 2 is a detail view of a workflow of the AI-based document analysis module; and

FIG. 3 is a detail view of a workflow of the life cycle cost analysis module.

For purposes of clarity and brevity, like elements and components will bear the same designations and numbering throughout the Figures.

### DETAILED DESCRIPTION

The present invention is directed to an automated artificial intelligence-based document and life cycle cost analysis method for solar energy contracts.

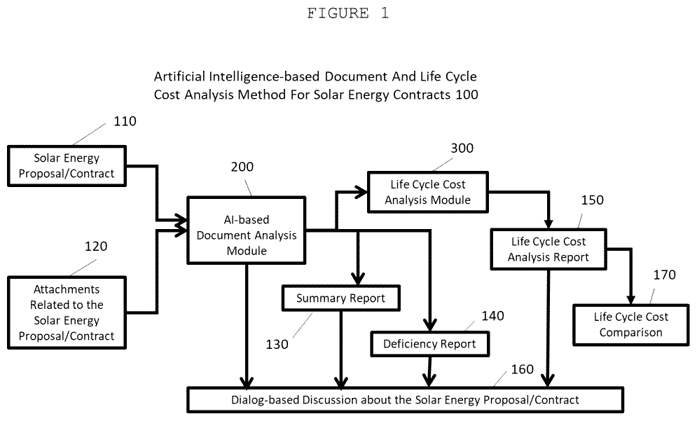

FIG. 1 is an overview of an artificial intelligence-based document and life cycle cost analysis method for solar energy contracts 100. The method takes a solar energy proposal/contract 110 and its attachments 120 as the main user inputs and transfers these documents to an AI-based document analysis module 200. The AI-based document analysis module 200 uses NLP and GPT to summarize the key insights of a solar energy proposal or contract to produce a summary report 130, find the deficiencies of a solar energy proposal or contract to produce a deficiency report 140, and extract the necessary input data for a life cycle cost analysis module 300.

The life cycle cost analysis module 300 accepts the input data from the AI-based document analysis module 200, acquires additional data from other sources like the internet and runs the life cycle cost analysis for the subject solar energy proposal or contract to produce the life cycle cost analysis report 150. If multiple solar energy proposals or contracts exist, a life cycle cost comparison 170 can be made for these proposals/contracts to determine the best option moving forward for the property owner.

In the AI-based document analysis module 200 and life cycle cost analysis module 300 a vector database will be created for solar energy proposal/contract 110 and its attachments 120, the summary report 130, the deficiency report 140 and the life cycle cost analysis report 150. The vector database will be used for a dialog-based discussion about solar energy proposal/contract 160, in which a user asks questions, and the system generates answers about the subject solar energy proposal/contract using NLP and GPT.

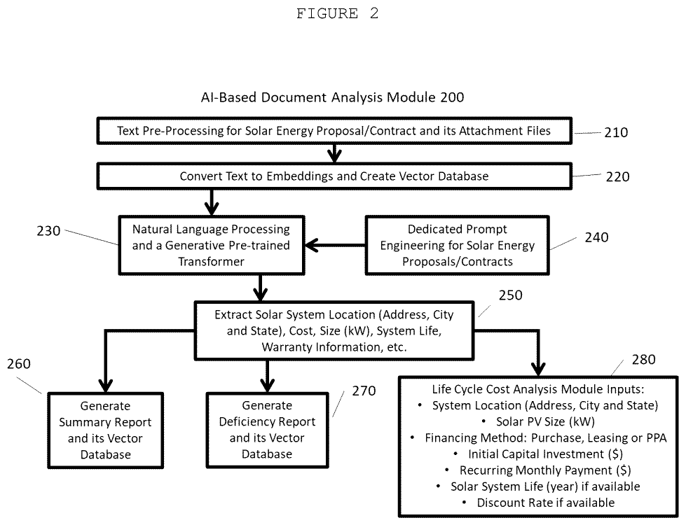

A detail view of a workflow of the AI-based document analysis module 200 is shown in FIG. 2. The AI-based document analysis module 200 starts with text pre-processing 210 for the input data—the solar energy proposal/contract and its attachment files in the PDF or Word format. In the text pre-processing 210, unnecessary characters will be removed from the input text and the text will be broken into smaller, manageable pieces called tokens. The pre-processed text is then converted to arrays of floating-point numbers called embeddings, and a vector database to hold the embeddings is created in process 220.

A dedicated prompt engineering process for solar energy proposals/contracts 240 is used to create prompts for the natural language processing and generative pre-trained transformer 230. The dedicated prompts may have the following contents:
Human: #Role

You are an extremely knowledgeable solar energy expert who has a deep understanding of solar energy and related contracts.
##Skills
###Skill 1: Analyzing Contracts
   Thoroughly analyze the “Solar Energy Contract”, breaking down its terms, structure, and procedures involved in its completion.
###Skill 2: Comprehending the Roles of Associated Firms
   Clarify the roles and responsibilities of companies involved in solar energy transactions, such as the general contractor, installer, and financing provider.

Please read the above contract carefully. Based on the page number defined, go through each page from the page beginning to the page end and get answers for the following questions. Please do it step by step.
##General Questions
1. What is the property address?
2. What is the solar PV size in kW?
3. What is the financing method, purchase, leasing or PPA?
4. What is the initial capital investment?
5. What is the recurring monthly payment?
6. What is the solar system life in years?
7. What is the discount or interest rate?

Dedicated prompts and a vector database are fed into a generative pre-trained transformer to generate a response using natural language processing in process 230. Examples of the generative pre-trained transformer are Open AI GPT3.5 or GPT 4.0 series. The response from process 230 will be used to extract solar system location (address, city and state), cost, size (kw), system life, warranty information, and system or contract deficiencies in process 250. The information is then used to generate summary report and its vector database in process 260, generate deficiency report and its vector database in process 270, and generate formatted life cycle cost analysis module inputs in process 280. The life cycle cost analysis module inputs may include:
System Location 310 (Address, City and State)
Solar PV Size (KW) 320
Financial Data 350:
   Financing Method: Purchase, Leasing or PPA
   Initial Capital Investment ($)
   Recurring Monthly Payment ($)
Solar System Life (year) 340 if available, if not available the default is 25 years.
Discount Rate 350 if available, if not available the default is per National Institute of Standards and Technology (NIST) Handbook 135, also known as the Life-Cycle Costing Manual for the Federal Energy Management Program

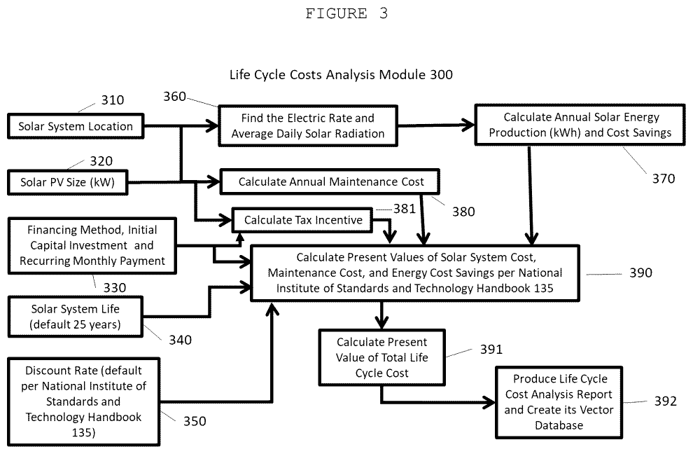

A detail view of a workflow of the life cycle cost analysis module 300 is shown in FIG. 3. The solar system location 310 and solar PV size 320 are used to find the electric rate ($ per kWh) and average daily solar radiation (Watt per square meter) per the local weather profile in process 360, then the annual solar energy production (kwh) and cost savings ($) from such solar system are calculated in process 370. The solar system location 310 and solar PV size 320 are also used to calculate annual maintenance cost per local labor rates in process 380. The solar system location 310, solar PV size 320, and financial data 330 are used to calculate tax incentive per federal, state, and local tax laws/regulations in process 381.

The core process 390 of the life cycle cost analysis module 300 aims to calculate present values of solar system cost, maintenance cost, and energy cost savings per National Institute of Standards and Technology Handbook 135 based on following input data:
annual solar energy production (kWh) and cost savings ($) from process 370
annual maintenance cost from process 380
tax incentive from process 381
financial data 330
solar system life 340
discount or interest rate 350

The present value of total life cycle cost will be calculated in process 391 by summing up all the present values calculated in process 390. Finally, a life cycle cost analysis report and its vector database are created in process 392.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An artificial intelligence-based document and life cycle cost analysis method for solar energy contracts, using the procedure described in FIG. 1 for generating summary, deficiency, and life cycle cost analysis reports automatically, comprising:
an AI-based document analysis module described in FIG. 2, using natural language processing and a generative pre-trained transformer to summarize key insights and deficiencies of a solar energy proposal or contract and extract the necessary input data from the solar energy proposal or contract for a life cycle cost analysis;
a life cycle cost analysis module described in FIG. 3, accepting the input data from the AI-based document analysis module, acquiring additional data from other sources like the internet and using industry standards to run the life cycle cost analysis for the subject solar energy proposal or contract.

2. The artificial intelligence-based document and life cycle cost analysis method for solar energy contracts of claim 1, wherein a life cycle cost comparison can be made for comparing present values of total life cycle costs and other economic data of multiple solar energy proposals or contracts.

3. The artificial intelligence-based document and life cycle cost analysis method for solar energy contracts of claim 1, wherein a dialog-based discussion about the solar energy proposal/contract can be conducted for users to ask questions and the system to dynamically generate answers.
